(19) United States
(12) Patent Application Publication
(10) Pub. No.: US 2026/0339478 A1
(43) Pub. Date: Oct. 29, 2026

(54) SYSTEMS, METHODS, AND USER INTERFACES FOR 3D CALENDARING AND TASK MANAGEMENT

(71) Applicant: Life Pilot Inc., Captain Cook, HI (US)

(72) Inventor: Timothy Joseph Farnum, Captain Cook, HI (US)

(21) Appl. No.: 19/658,697

(22) Filed: Apr. 26, 2026

Related U.S. Application Data
(60) Provisional application No. 63/795,421, filed on Apr. 27, 2025.
(60) Provisional application No. 63/819,773, filed on Jun. 8, 2025.
(60) Provisional application No. 63/820,734, filed on Jun. 10, 2025.

(51) Int. Cl. G06F 3/04815; G06F 3/0484; G06F 40/205; G06Q 10/109

(52) U.S. Cl. CPC G06F 3/04815; G06F 3/0484; G06Q 10/1097; G06F 40/205

(57) ABSTRACT

The implementations described include methods, systems, and interfaces for three-dimensional life calendaring, task scheduling, and goal management. A computer displays a graphical user interface depicting a simulated three-dimensional navigable pathway representing a timeline. This pathway includes a central lane extending forward with incremental date blocks, parallel life lanes, horizon markers representing goals rendered as mountain shapes, and task markers representing individual tasks. Tasks with nearer deadlines appear more visually prominent and closer to the current position, while those with later deadlines appear smaller and further away. Users can add tasks by specifying a life lane, date, time, duration, urgency, and importance. Each task is then spatially arranged on its designated lane at a position reflecting its deadline. Users can navigate forward or backward along the pathway, dynamically updating the display of task markers relative to their current position in the timeline.

### RELATED APPLICATIONS

This application claims the benefit of and priority to U.S. Provisional Patent Application No. 63/795,421, filed Apr. 27, 2025, titled “Life-Pilot: A Novel First-Person 3-D Calendar and AI-Enhanced Life Navigator,” which is incorporated by reference herein in its entirety.

This application claims the benefit of and priority to U.S. Provisional Patent Application No. 63/819,773, filed Jun. 8, 2025, titled “Life-Pilot: System and Method for Context-Aware Personal Planning, Executive Function Support, and Adaptive Life Management,” which is incorporated by reference herein in its entirety.

This application claims the benefit of and priority to U.S. Provisional Patent Application No. 63/820,734, filed Jun. 10, 2025, titled “LIFE PILOT: Further Embodiments and Expanded System Details,” which is incorporated by reference herein in its entirety.

### TECHNICAL FIELD

The disclosed implementations relate generally to digital calendaring, task scheduling, and goal management systems, and more specifically to methods, systems, and user interfaces for immersive three-dimensional calendaring, task scheduling, and goal management in which scheduled items are rendered as spatially arranged visual indicators along a three-dimensional navigable, forward-extending timeline segmented into user-defined life-domain regions, including artificial intelligence agent modules and interactive agent consoles for autonomously executing tasks and delivering real-time feedback within a first-person planning environment.

### BACKGROUND

Existing calendar and task-management applications present scheduled items or tasks through linear or two-dimensional, text-oriented displays that fail to reflect the way humans naturally conceptualize future tasks as points along a forward-extending visual path. Such conventional formats fragment planning workflows and impose a cognitive burden on users who must mentally translate static calendar entries into real-world execution steps.

### SUMMARY

Disclosed are new systems, methods, and user interfaces that place the user in the cockpit of their own life, a first-person, three-dimensional planning environment in which daily tasks, long-term goals, and calendar events are unified into a single, continuous visual space. Rather than passively reviewing a static schedule, the user occupies the pilot's seat, looking forward through a navigable timeline that proactively surfaces what is coming, with near-term deadlines approaching from the foreground and long-range goals anchored on the horizon. The environment is organized into distinct life-domain lanes spanning areas such as health, family, finance, and work, that are spatially adjacent and visually interactive, such that tasks and milestones across lanes inform and influence one another, reflecting the interconnected nature of real-life planning. The result is not an incremental improvement to conventional calendaring but a fundamental reimagining of how people engage with their time, intentions, and priorities.

The present invention provides a system and method for delivering an immersive, first-person three-dimensional calendaring and life-management experience in which scheduled tasks, personal goals, and calendar events are rendered as spatially arranged visual indicators along a forward-extending, navigable timeline organized into user-defined life-domain lanes. The system further provides an AI agent layer, accessible through interactive cockpit-style consoles, that receives user input via natural language, touch, or voice, and autonomously executes planning-related operations including task scheduling, external service integrations, and real-time notifications, while delivering continuous visual and auditory feedback within the three-dimensional environment.

In accordance with some implementations, a method is disclosed for facilitating a user's planning and task-management workflows. The method includes displaying a graphical user interface depicting a simulated 3D perspective of a navigable pathway representing a timeline. The navigable pathway of graphical user interface further includes (a) a central lane, extending in a forward direction, (b) a plurality of blocks placed incrementally along the central lane, each block representing a respective date, which, upon user selection of a date, expands to display more granular time intervals for the selected date, (c) a plurality of life lanes, arranged perceptively parallel to central lane, and extending in the forward direction, (d) a plurality of horizon markers appearing perceptively near a far end of the plurality of the life lanes, each horizon marker representing a goal displayed as a mountain of a respective life lane, and (e) a plurality of task markers, each task marker representing a respective task. Where each task marker corresponding to a respective task having nearer temporal deadline is displayed with greater visual prominence and positioned perceptively nearer to a current temporal position on its respective life lane and each task marker corresponding to a respective task having later temporal deadline is displayed with reduced visual prominence and positioned perceptively further away on its respective life lane. The method further includes receiving, via the graphical user interface, user input to add a task, wherein the user input specifies one or more of: (a) a first life lane of the plurality of life lanes; (b) a date; (c) a time; (d) a duration; (e) an urgency of the task; and (f) an importance of the task. Based on the user input, spatially arranging the task as a task marker on the first life lane. The method further includes, in response to user input to navigate in the graphical user interface, navigating forward or backward in the simulated 3D perspective and displaying an updated set of task markers according to a current position in the timeline.

In accordance with some implementations, the method includes a graphical user interface providing a plurality of alternative temporal perspectives with different time granularity.

In accordance with some implementations, plurality of alternative temporal perspectives include daily, weekly, monthly, and yearly perspectives.

In accordance with some implementations, the method includes receiving user input to specify a second task that is associated with two or more of the life lanes. The method further includes receiving user input to specify (a) a measure of impact of the second task on the two or more life lanes, (b) a duration of the second task, and/or (c) a user-specified importance of the second task. In response to the user input to specify the second task, the method further includes generating, on the display, a convergence indicator for the second task, wherein the convergence indicator: (a) is visually distinguished from other task markers, (b) extends across the two or more life lanes at a single temporal position, and (c)includes a luminous visual signal emanating outward across the two or more life lanes, illuminating a respective portion of each of the two or more life lanes.

In accordance with some implementations, the method includes (a) maintaining the convergence indicator as a persistent visual element at a historical temporal position corresponding to the second task when the user navigates to historical temporal positions within the navigable pathway, wherein the convergence indicator remains visually distinguishable at the historical temporal positions and (b) recording attributes of the second task in a persistent data structure that accumulates a history of tasks satisfying one or more configurable thresholds across the plurality of life lanes. The method further includes, based on the persistent data structure, performing one or more of: (a) identifying and displaying task markers having attributes corresponding to the recorded attributes during user navigation of the navigable pathway and/or (b) assigning a priority weight to future tasks having attributes corresponding to the recorded attributes and displaying the future tasks within the navigable pathway in accordance with the assigned priority weight.

In accordance with some implementations, method further includes operating one or more AI-agents in conjunction with the graphical interface to perform one or more of: (a) scheduling or rescheduling the plurality of tasks, (b) executing an integration with one or more external services, (c) initiating real-time communications with one or more users, (d) generating optimization recommendations for the plurality of tasks, and/or (e) updating the graphical interface to reflect changes or status information produced by the AI-agent, including displaying real-time visual or auditory feedback to the user.

In accordance with some implementations, the AI-agents include one or more of: (a) a natural language understanding module configured to parse user-generated inputs and extract intent, entities, or commands relevant to scheduling or rescheduling the plurality of tasks, (b) a resource management module configured to identify resource availability, resolve conflicts, and prioritize task execution across the plurality of tasks, (c) a notification dispatch module configured to initiate real-time visual or auditory notifications to affected users upon detection of a scheduling change, conflict, or AI-agent recommendation, and/or (d) a project planning module configured to (i) analyze upcoming deadlines, (ii) generate recommendation beacons for incomplete prerequisites, and (iii) present choices via agent avatars.

In accordance with some implementations, an AI-agent is configured to synchronize with existing calendar and other productivity platforms used by the user.

In accordance with some implementations, the other productivity platforms used by the user include one or more of: Google Calendar, Apple Calendar, Gmail services, Outlook services, and other reminder applications.

In accordance with some implementations, the method includes rendering an AI console within the graphical interface. The AI console is configured to provide a user interaction layer between the user and the one or more AI-agents. Further, the AI console is configured to (a) display real-time status information of each AI-agent, (b) receive user input to override, approve, or reject an action proposed or executed by an AI-agent, (c) present logs, alerts, or optimization recommendations generated by the one or more AI-agents, and/or (d) suggest a plurality of goals that can be assigned to horizon markers.

In accordance with some implementations, the method includes suggesting a plurality of goals. The step of suggesting a plurality of goals, includes: generating, for each suggested life goal assigned to a horizon marker of a respective life lane, a multi-step progression plan including: (a) a respective plurality of incremental goals distributed at successive temporal positions along the respective life lane within the navigable pathway, each incremental goal representing a respective intermediate milestone toward a respective final goal assigned to a respective horizon marker and (b) displaying each incremental goal as a task marker on the respective life lane at a respective temporal position within the navigable pathway so that the respective plurality of incremental goals collectively define a respective visual progression path toward the respective horizon marker.

In accordance with some implementations, the method includes receiving user input to specify size, color intensity, or proximity of a task marker corresponding to an urgent task

In accordance with some implementations, the method includes receiving user input to specify traversal of the navigable pathway by flying or driving, and, in response, displaying the navigable pathway according to the traversal specification.

In accordance with some implementations, the method includes receiving taps, swipes, voice commands from the user to traverse the navigable pathway.

In accordance with some implementations, the method include receiving user input to designate a second task marker as a signpost, an icon, a volumetric object, or other visual element.

In accordance with some implementations, the plurality of life lanes define a life theme, including one or more of: a health lane, a family lane, a wealth lane, a love lane, a work lane, a faith lane, a mission lane, a creativity lane, and/or a social life lane

In accordance with some implementations, the plurality of life lanes are customizable by the user.

In accordance with some implementations, each task marker is positioned either on a simulated ground plane or at an elevation or orientation within the simulated 3D navigable perspective so that each task marker can hover, ascend, descend, or be arranged volumetrically as needed to convey additional semantic or contextual information.

In accordance with some implementations, respective perceived distance of each task marker from the user's navigable view is directly proportional to a time remaining until the a respective due date of the respective task, according to a linear scale or a logarithmic scale.

In accordance with some implementations, users can add a plurality of sub-lanes within the plurality of life lanes.

In accordance with some implementations, a computing device includes one or more processors, memory, a display, and one or more programs stored in the memory. The programs are configured for execution by one or more processors. The one or more programs include instructions for performing any of the methods described herein.

In some implementations, a non-transitory computer-readable storage medium stores one or more programs configured for execution by a computing device having one or more processors, memory, and a display. The one or more programs include instructions for performing any of the methods described herein.

In various circumstances, the systems and methods of the present disclosure have the following advantages over the conventional methods of scheduling tasks and goals in a 2D linear environment. A first advantage is that by placing the user inside a navigable, first-person three-dimensional environment, the system eliminates the cognitive burden of mentally translating static calendar entries into real-world execution, aligning the planning interface with the way humans naturally visualize and anticipate future events along a forward-extending path. A second advantage is that by organizing tasks, goals, and calendar events into spatially adjacent life-domain lanes that visually interact with one another, the system surfaces cross-domain dependencies and competing priorities that conventional two-dimensional calendar grids and linear task lists fail to reveal, enabling more informed and balanced life planning. A third advantage is that by integrating artificial intelligence agent modules and interactive consoles directly within the planning environment, the system enables autonomous task execution, real-time optimization recommendations, and seamless third-party service integrations without requiring the user to exit the planning interface or navigate separate applications. A fourth advantage is that by encoding temporal urgency through the spatial proximity of task markers to the user's viewpoint, the system delivers an immediate and intuitive understanding of approaching deadlines and milestone status without requiring the user to interpret numerical dates, color codes, or textual priority labels as required by conventional applications. A fifth advantage is that the system supports fully customizable themes, life-domain configurations, and agent personas, allowing the interface to adapt to individual cognitive styles, personal preferences, and domain-specific planning requirements without departing from the underlying three-dimensional planning framework.

Thus, methods are disclosed for formalizing the qualitative dynamics of the movement of a human body by introducing a structured spatiotemporal representation that includes a set of spatiotemporal qualitative parameters. Such methods and systems may complement or replace conventional methods of computational movement analysis.

### BRIEF DESCRIPTION OF THE DRAWINGS

For a better understanding of the aforementioned methods that provide a structured spatiotemporal representation, reference should be made to the Description of Implementations below, in conjunction with the following drawings in which reference numerals refer to corresponding parts throughout the figures.

FIG. 1 illustrates diagrammatic overview of a graphical user interface depicting a simulated 3D perspective of a navigable pathway in accordance with some implementations.

FIG. 2 illustrates a task creation dialog of a graphical user interface, through which the user inputs the attributes of a new task marker for placement on the navigable pathway, in accordance with some implementations.

FIG. 3 is a screen shot of a task creation dialog of a graphical user interface in an operational state, displaying a populated example of task entry in accordance with some implementations.

FIG. 4 is a screen shot of assigning a task to more than one life lanes in a graphical user interface in accordance with some implementations.

FIG. 5 is a screenshot of a graphical user interface displaying the navigable pathway in an operational state, and specifically depicts a convergence indicator rendered within the simulated three-dimensional perspective across multiple life lanes in accordance with some implementations.

FIG. 6 shows an AI console dialog of a graphical user interface, identified as the LifePilot AI console, through which the user engages the AI console to create tasks, set goals, and receive planning assistance within the navigable pathway environment, in accordance with some implementations.

FIG. 7 is a screenshot of an AI console dialog of a graphical user interface displayed in an operational state overlaid on the navigable pathway environment, in accordance with some implementations.

FIGS. 8A and 8B are screenshots of an AI console dialog of a graphical user interface displaying an AI-generated plan in response to a natural language command entered by the user, in accordance with some implementations.

FIG. 9 is a block diagram of an example computing device in accordance with some implementations.

FIG. 10 is a block diagram of an example user device in accordance with some implementations.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF IMPLEMENTATIONS

The present invention provides an immersive, first-person three-dimensional calendaring, task scheduling, and goal management system in which the user is placed in the cockpit of their own life. Daily tasks, calendar events, and long-term goals are unified into a single continuous visual space and rendered as spatially arranged visual indicators along a navigable, forward-extending timeline. The timeline is partitioned into life-domain lanes spanning areas such as health, family, finance, and work, wherein tasks and milestones across lanes are spatially adjacent and visually interactive, reflecting the interconnected nature of real-life planning. Temporal urgency is communicated intuitively through the spatial proximity of task markers to the user's viewpoint, with near-term deadlines surfacing from the foreground and long-range goals anchored on the horizon. The user engages artificial intelligence agents through interactive AI consoles embedded within the cockpit-style interface to autonomously execute tasks, receive real-time optimization recommendations, and trigger seamless third-party service integrations, all without exiting the planning environment. The system further supports customizable themes, life-domain configurations, and agent personas, accommodating individual cognitive styles and planning preferences. The result is a fundamental reimagining of how people engage with their time, intentions, and priorities, transforming passive schedule review into an active, spatially intuitive, and proactive planning experience.

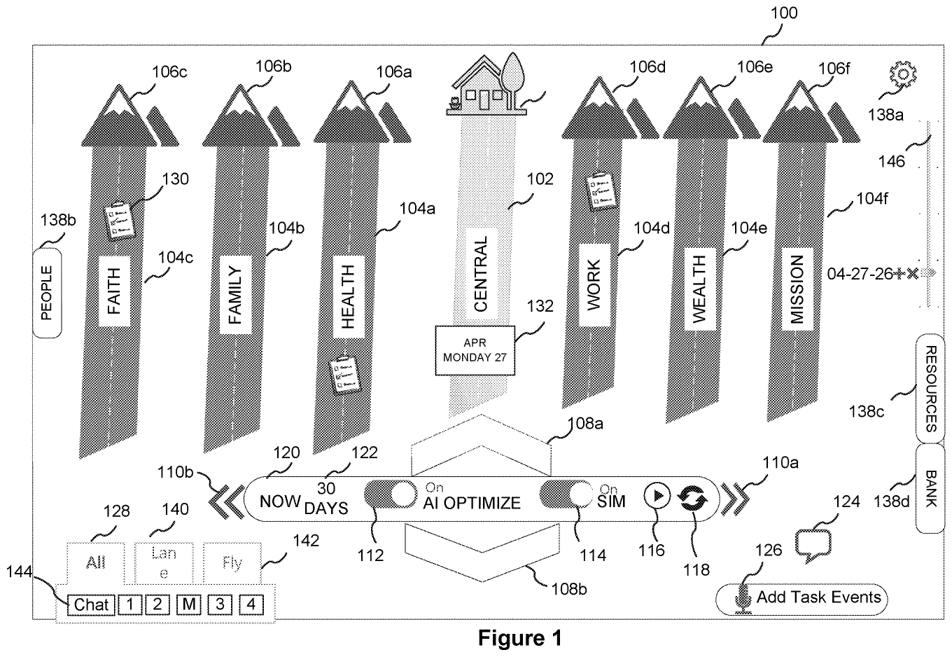

FIG. 1 illustrates a graphical user interface 100 depicting a simulated three-dimensional perspective of a navigable pathway representing a timeline, in accordance with some implementations. The graphical user interface 100 presents the timeline from a first-person viewpoint, placing the user at the current temporal position and rendering scheduled items, goals, and life-domain lanes as spatially arranged visual elements that extend in a forward direction toward a vanishing point on the horizon.

The graphical user interface 100 includes a central lane 102 that extends in the forward direction along the navigable pathway of the simulated three-dimensional perspective. The central lane 102 serves as the primary temporal reference of the navigable pathway. A plurality of date blocks 132 are placed incrementally along the central lane 102, each date block 132 representing a respective date. In some implementations, when the user selects a date block 132, the graphical user interface 100 expands the selected date block 132 to display more granular time intervals for the selected date, enabling the user to view and interact with hour-level or minute-level scheduling detail within that date.

The graphical user interface 100 further includes a plurality of life lanes 104a-104f arranged perceptively parallel to the central lane 102 and extending in the forward direction along the navigable pathway. In some implementations, the life lanes 104a-104f correspond to user-defined life-domain categories such as spiritual life, health, family, work, business, and finance. The life lanes 104a-104f partition the base plane of the simulated three-dimensional perspective into spatially distinct regions, enabling the user to visually organize and manage tasks and goals according to their respective life domains. In some implementations, the user may define any number of life lanes 104a-104f, assign custom labels, and adjust their visual attributes without departing from the scope of the invention.

The graphical user interface 100 further includes a plurality of horizon markers 106a-106f appearing perceptively near a far end of the plurality of life lanes 104a-104f. Each horizon marker 106a-106f represents a long-term goal associated with a respective life lane 104a-104f, rendered as a mountain shape positioned on the horizon of the simulated three-dimensional perspective. The horizon markers 106a-106f remain persistently visible within the graphical user interface 100, providing the user with a continuous visual anchor for long-term objectives across each life domain. In some implementations, each horizon marker 106a-106f is selectable, such that user selection opens a detail panel displaying information associated with the corresponding long-term goal.

The graphical user interface 100 further includes a plurality of task markers 130, each task marker 130 representing a respective task assigned to a life lane 104a-104f. The graphical user interface 100 encodes temporal urgency through the spatial position and visual prominence of each task marker 130 relative to the user's current temporal position along the navigable pathway. Specifically, each task marker 130 corresponding to a task having a nearer temporal deadline is displayed with greater visual prominence and positioned perceptively closer to the current temporal position on its respective life lane 104a-104f. Each task marker 130 corresponding to a task having a later temporal deadline is displayed with reduced visual prominence and positioned perceptively further away along the navigable pathway on its respective life lane 104a-104f. In some implementations, task markers 130 approaching their deadline increase in size, intensify in color, or emit visual pulsing effects to further communicate urgency to the user.

In some implementations, the graphical user interface 100 further includes a control panel (numeral not shown) positioned in a central region of the interface, providing the user with a suite of navigation and mode controls for traversing and interacting with the navigable pathway. The control panel includes a set of navigator arrows comprising a forward arrow 108a and a backward arrow 108b, enabling the user to drive forward along the navigable pathway to preview future tasks and goals as they recede into the distance, or to fly backward through past timelines to review completed tasks and milestones in sequence. The control panel further includes a left arrow 110b and a right arrow 110a, enabling the user to pan laterally across the life lanes 104a-104f within the simulated three-dimensional perspective. A play button 118 enables the user to initiate automatic forward movement along the navigable pathway without manual input, and a pause icon 116 enables the user to halt navigation and remain at the current temporal position. A jump-to-now icon 120 enables the user to return immediately to the current temporal position from any point along the navigable pathway.

The control panel further includes an AI optimization toggle 112, which, when activated, enables an AI optimization function that analyzes task markers 130 across the life lanes 104a-104f and generates recommendations for re-sequencing, reprioritization, or resource reallocation. A simulation toggle 114 enables the user to turn the simulated three-dimensional environment on or off, presenting the same underlying timeline data in an alternative rendering mode. A life lane overview control 128 enables the user to view all life lanes 104a-104f simultaneously in a consolidated panoramic display. A lane navigation control 140 enables the user to navigate to a particular life lane selected from a set of available lanes, including lanes designated 1, 2, M, 3, and 4. A fly mode control 142 enables the user to engage an immersive fly-through navigation mode in which the graphical user interface 100 animates forward movement along the navigable pathway, rendering task markers 130 and horizon markers 106a-106f with full depth and parallax effects.

As the user navigates forward or backward along the navigable pathway, the graphical user interface 100 displays an updated set of task markers 130 reflecting the current temporal position. Future task markers 130 may be dragged, edited, or reprioritized in situ, and the graphical user interface 100 immediately re-flows downstream milestones and flags any temporal conflicts or resource clashes resulting from the modification. Task markers 130 representing past events remain immutable within the graphical user interface 100, providing the user with an accurate historical record of completed tasks and milestones. In some implementations, by navigating forward or backward through alternative future timeline arrangements, the user can visualize how different task orderings affect downstream outcomes, enabling strategic re-sequencing that optimizes time, resources, or success probability. In some implementations, the graphical user interface includes a chat interface 144 to provide feedback to the administrator.

The graphical user interface 100 further includes an AI console 124 through which the user engages artificial intelligence agents to receive planning recommendations, execute tasks autonomously, and manage scheduling operations within the navigable pathway environment. A task creation icon 126 enables the user to add a new task marker 130 to a life lane 104a-104f, and in some implementations, the task creation icon 126 further enables the user to intake task details via voice command, allowing hands-free task entry within the graphical user interface 100.

The graphical user interface 100 further includes a settings icon 138a, through which the user accesses system configuration and personalization options. A people tab 138b enables the user to manage contacts, collaborators, and social connections associated with tasks and life lanes 104a-104f. A resources tab 138c enables the user to view and allocate resources associated with tasks and goals across the life lanes 104a-104f. A bank tab 138d enables the user to access financial information and budget-related data linked to tasks and goals within the navigable pathway environment.

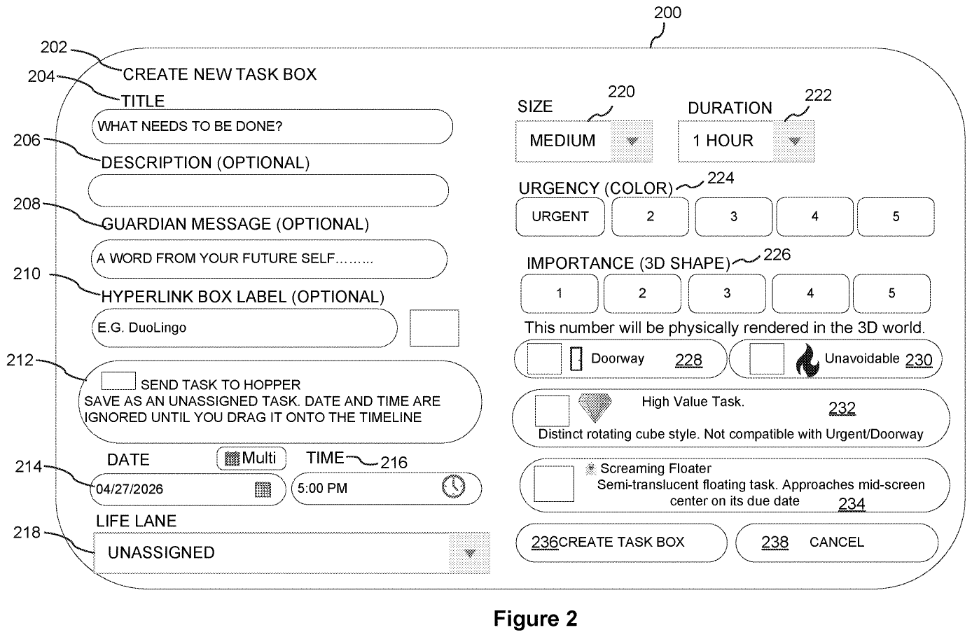

FIG. 2 illustrates a task creation dialog 200 of the graphical user interface 100, through which the user inputs the attributes of a new task marker 130 for placement on the navigable pathway, in accordance with some implementations. The task creation dialog 200 is overlaid on the graphical user interface 100 and organizes task input fields into a left panel and a right panel, enabling the user to define both the identity and the visual rendering properties of the task marker 130 prior to placement on a life lane 104a-104f.

The task creation dialog 200 includes a header 202 labeled “Create New Task Box,” identifying the dialog as the entry point for creating a new task marker 130 within the navigable pathway environment. A title field 204 prompts the user to enter a title for the task, displaying the placeholder text “What Needs to Be Done?” to guide user input. A description field 206 enables the user to enter an optional longer-form description of the task. A guardian message field 208 enables the user to enter an optional motivational or contextual message associated with the task, displayed with the placeholder text “A Word From Your Future Self . . . ” providing the user with a mechanism to attach forward-looking guidance to the task marker 130. A hyperlink box label field 210 enables the user to associate an optional external hyperlink with the task marker 130, displayed with the placeholder text “E.G. DuoLingo,” together with a corresponding link preview box. The task creation dialog 200 further includes a send-to-hopper control 212 that, when selected, saves the task as an unassigned task in a hopper queue, wherein the date and time attributes of the task are ignored until the user drags the task marker 130 onto the navigable pathway.

A date field 214 enables the user to specify the date associated with the task, displaying a calendar input control and a multi-date selection option. A time field 216 enables the user to specify the time of the task using a time input control. A life lane selector 218 provides a dropdown menu enabling the user to assign the task to a specific life lane 104a-104f, defaulting to an unassigned state until the user selects a life lane.

A size selector 220 provides a dropdown menu enabling the user to specify the physical size at which the task marker 130 is rendered within the simulated three-dimensional perspective, with options including Medium and other available sizes. A duration selector 222 provides a dropdown menu enabling the user to specify the duration of the task, with options including one hour and other available durations.

An urgency selector 224, labeled “Urgency (Color),” enables the user to specify the urgency level of the task on a scale from Urgent through five discrete levels, wherein the selected urgency level determines the color rendering of the task marker 130 within the navigable pathway. An importance selector 226, labeled “Importance (3D Shape),” enables the user to specify the importance level of the task on a scale from one through five, wherein the selected importance level determines the three-dimensional shape in which the task marker 130 is rendered within the simulated environment, with the graphical user interface 100 displaying the notation that the selected number will be physically rendered in the three-dimensional world.

The task creation dialog 200 further presents four task marker rendering styles from which the user may select. A doorway style 228 renders the task marker 130 as a doorway-shaped visual indicator within the navigable pathway. An unavoidable style 230, represented by a flame icon, renders the task marker 130 as a high-urgency indicator that commands prominent visual attention within the navigable pathway. A high value task style 232, represented by a diamond icon, renders the task marker 130 as a distinct rotating cube, with the graphical user interface 100 noting that this style is not compatible with the Urgent or Doorway rendering styles. A screaming floater style 234 renders the task marker 130 as a semi-translucent floating indicator that progressively approaches the center of the screen as the task's due date nears, providing an escalating visual alert tied directly to temporal urgency.

A create task box button 236 enables the user to confirm all entered attributes and spatially arrange the task as a task marker 130 on the selected life lane 104a-104f at a position along the navigable pathway reflecting the task's temporal deadline relative to the user's current temporal position. A cancel button 238 enables the user to dismiss the task creation dialog 200 without creating a task marker 130.

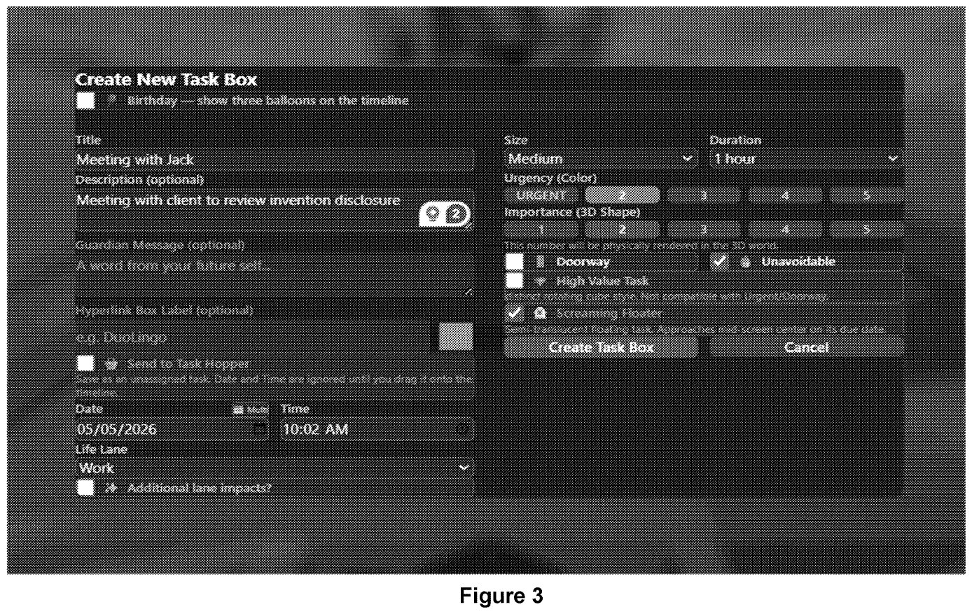

FIG. 3 is a screen shot of the task creation dialog 200 of the graphical user interface 100 in an operational state, displaying a populated example of task entry in accordance with some implementations. FIG. 3 depicts the same task creation dialog 200 introduced in FIG. 2 with all interactive fields actively populated, and further reveals additional interface elements not shown in FIG. 2.

The task creation dialog 200 displays a special event indicator 240 positioned at the top of the dialog, rendered as a highlighted row containing a checkbox and a descriptive label identifying the event type, in this example “Birthday —show three balloons on the timeline.” The special event indicator 240 enables the user to designate a task marker 130 as a special occasion, triggering a themed visual rendering within the navigable pathway, such as balloon indicators appearing on the timeline on the designated date.

The title field 204 displays the user-entered task title “Meeting with Jack.” The description field 206 displays the user-entered description “Meeting with client to review invention disclosure,”. The guardian message field 208 displays the placeholder text “A word from your future self . . . ” indicating that no guardian message has been entered for this task. The hyperlink box label field 210 displays the placeholder text “e.g. DuoLingo” alongside a colored link preview box, indicating that no hyperlink has been assigned. The send-to-hopper control 212 is displayed in an unselected state, indicating that the task will be placed directly onto the navigable pathway upon creation rather than saved to the hopper queue.

The date field 214 displays the user-selected date of May 5, 2026 together with the multi-date selection option, and the time field 216 displays the user-selected time of 10:02 AM. The life lane selector 218 displays the user-selected life lane “Work,” assigning the task marker 130 to the corresponding life lane 104a-104f upon creation. The task creation dialog 200 further includes an additional lane impacts control, enabling the user to designate that the task affects one or more life lanes 104a-104f beyond the primary assigned lane, allowing the graphical user interface 100 to reflect cross-domain dependencies within the navigable pathway.

The size selector 220 displays the user-selected size “Medium” and the duration selector 222 displays the user-selected duration of “1 hour.” The urgency selector 224 displays the “Urgent” level actively selected and level 2 highlighted in orange, indicating that the task marker 130 will be rendered in the corresponding urgency color within the navigable pathway. The importance selector 226 displays level 2, indicating that the task marker 130 will be rendered in the corresponding three-dimensional shape within the simulated environment.

Among the rendering style options, the unavoidable style 230 is shown in a selected state, indicating that the task marker 130 will be rendered as a high-urgency flame-style indicator within the navigable pathway. The screaming floater style 234 is also shown in a selected state, indicating that the task marker 130 will additionally render as a semi-translucent floating indicator that progressively approaches the center of the screen as the task's due date nears. The doorway style 228 and high value task style 232 are displayed in unselected states. The create task box button 236 and cancel button 238 are displayed at the bottom of the task creation dialog 200, enabling the user to confirm task creation or dismiss the dialog respectively.

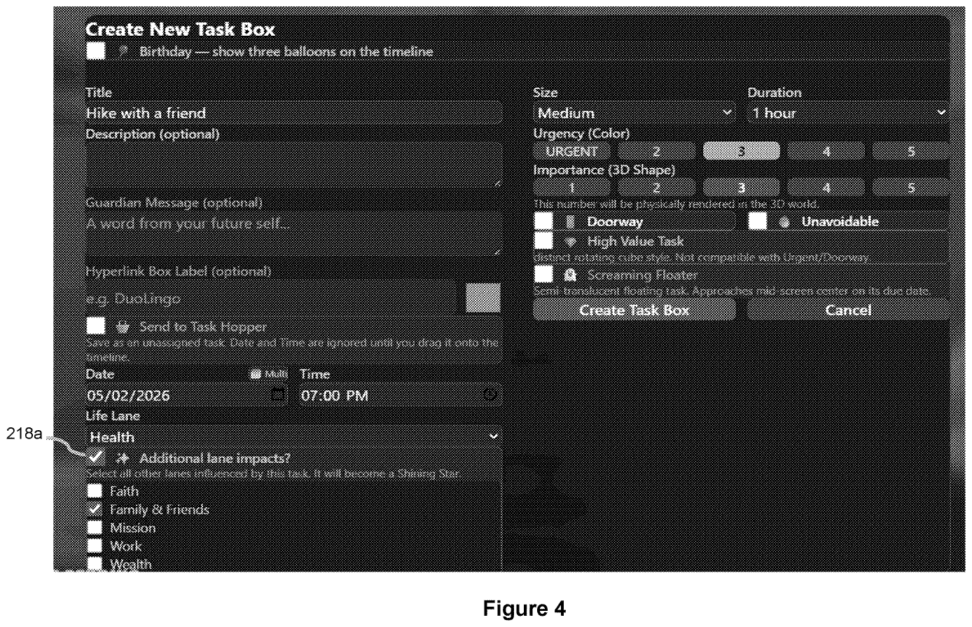

FIG. 4 illustrates the task creation dialog 200 of the graphical user interface 100 with the additional lane impacts dropdown menu 218a expanded, in accordance with some implementations. FIG. 4 depicts the same task creation dialog 200 introduced in FIGS. 2 and 3, and specifically illustrates the cross-domain dependency assignment functionality available to the user when creating a task marker 130 that affects multiple life lanes 104a-104f.

The title field 204 displays the user-entered task title “Hike with a friend.” The description field 206, guardian message field 208, and hyperlink box label field 210 are displayed in unpopulated states, indicating that no optional supplementary information has been entered for this task. The send-to-hopper control 212 is displayed in an unselected state. The date field 214 displays the user-selected date of May 2, 2026 and the time field 216 displays the user-selected time of 07:00 PM. The life lane selector 218 displays the user-selected life lane “Health,” assigning the task marker 130 to the corresponding life lane 104a-104f as its primary domain.

The additional lane impacts dropdown menu 218a is displayed in an actively selected and expanded state, having been enabled by the user. The dropdown menu 218a reveals a list of all available life lanes 104a-104f as selectable options. The graphical user interface 100 displays the instruction “Select all other lanes influenced by this task. It will become a Shining Star,” indicating that when the user designates a task marker 130 as affecting multiple life lanes 104a-104f, the graphical user interface 100 renders that task marker 130 with a distinct Shining Star visual style within the navigable pathway, visually distinguishing it from single-domain task markers 130. The dropdown menu 218a displays the following life lanes as selectable checkboxes: Faith, Family and Friends, Mission, Work, and Wealth. In the illustrated implementation, the Family and Friends lane is shown in a selected state, indicating that the user has designated the task “Hike with a friend” as impacting both the Health life lane and the Family and Friends life lane simultaneously. The remaining life lanes, Faith, Mission, Work, and Wealth, are displayed in unselected states.

The size selector 220 displays the user-selected size “Medium” and the duration selector 222 displays the user-selected duration of “1 hour.” The urgency selector 224 displays level 3 actively selected and highlighted in orange, and the importance selector 226 displays level 3 actively selected and highlighted in purple, indicating that the task marker 130 will be rendered with the corresponding color and three-dimensional shape within the simulated environment. All four rendering style options, doorway style 228, unavoidable style 230, high value task style 232, and screaming floater style 234, are displayed in unselected states. The create task box button 236 and cancel button 238 are displayed at the bottom of the task creation dialog 200, enabling the user to confirm task creation or dismiss the dialog respectively.

In some implementations, when the user selects two or more life lanes 104a-104f through the additional lane impacts dropdown menu 218a and the specified task meets one or more configurable thresholds for impact, duration, or user-defined importance, the graphical user interface 100 generates a convergence indicator for the task marker 130 on the navigable pathway. The convergence indicator is visually distinguished from other task markers 130 and is rendered as a luminous star-shaped visual marker, referred to herein as a Shining Star, that extends across the two or more life lanes 104a-104f at a single temporal position along the navigable pathway. The convergence indicator emits a luminous visual signal that radiates outward across the two or more life lanes 104a-104f, illuminating a respective portion of each affected life lane 104a-104f, thereby visually identifying the task as a high-leverage activity that produces meaningful benefit across multiple life domains simultaneously. For example, a task such as “Hike with a friend” assigned primarily to the Health life lane and additionally to the Family and Friends life lane generates a convergence indicator that spans both life lanes 104a-104f at the task's temporal position, reflecting the simultaneous health and social benefit produced by the single activity.

In some implementations, the graphical user interface 100 maintains the convergence indicator as a persistent visual element at the historical temporal position corresponding to the task when the user navigates to historical temporal positions within the navigable pathway, such that the convergence indicator remains visually distinguishable within the historical record. The graphical user interface 100 records the attributes of the task in a persistent data structure that accumulates a history of tasks satisfying one or more configurable thresholds across the plurality of life lanes 104a-104f. Based on the persistent data structure, the graphical user interface 100 performs one or more of: identifying and displaying task markers 130 having attributes corresponding to the recorded attributes during user navigation of the navigable pathway, enabling the user to recognize patterns of high-leverage activity across life domains; and assigning a priority weight to future tasks having attributes corresponding to the recorded attributes and displaying those future tasks within the navigable pathway in accordance with the assigned priority weight, enabling the system to proactively surface and prioritize activities likely to produce convergence events across multiple life lanes 104a-104f. In some implementations, the system further analyzes the historical density of convergence indicators within the navigable pathway to guide lifestyle optimization recommendations and AI-driven prioritization of similar future activities.

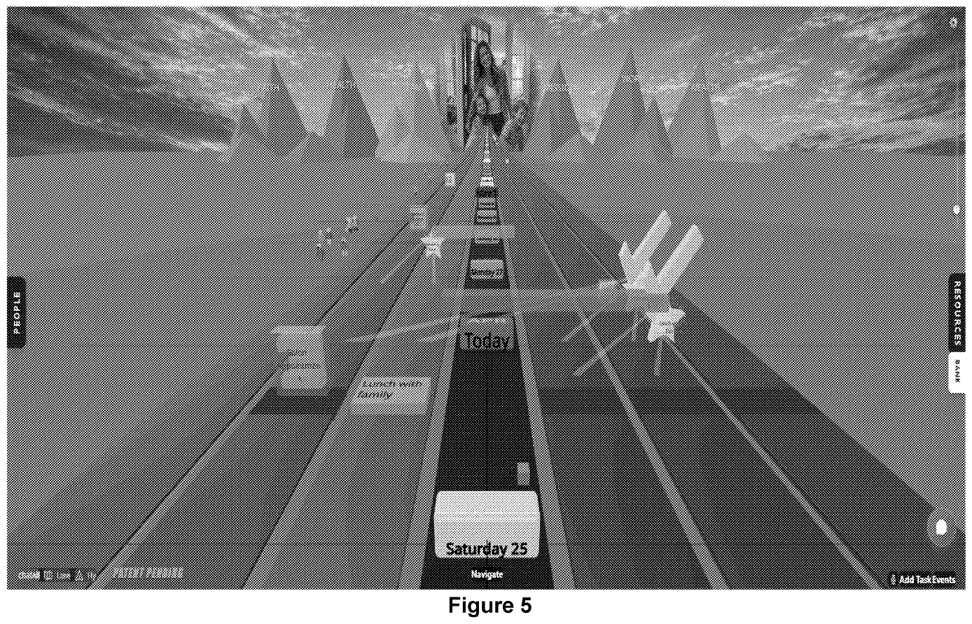

FIG. 5 illustrates the graphical user interface 100 displaying the navigable pathway in an operational state, and specifically depicts a convergence indicator rendered within the simulated three-dimensional perspective across multiple life lanes 104a-104f, in accordance with some implementations. FIG. 5 provides an exemplary view of the graphical user interface 100 as the user navigates the navigable pathway in real time, with task markers 130, date blocks 132, horizon markers 106a-106f, and the convergence indicator simultaneously visible within the simulated environment.

The life lanes 104a-104f extend in the forward direction along the navigable pathway and are visible in the illustrated implementation as spatially distinct parallel lanes corresponding to the life-domain categories Faith, Health, Family, Mission, Work, and Wealth, each labeled above its respective horizon marker 106a-106f. The horizon markers 106a-106f are rendered as stylized mountain shapes of varying colors positioned along the horizon of the simulated three-dimensional perspective, providing the user with a persistent visual anchor for long-term goals across each life domain. A personal vision image 150 is displayed at the center of the horizon, positioned above the vanishing point of the navigable pathway, representing a user-defined aspirational image associated with the central lane 102 and long-term life vision.

A plurality of date blocks 132 are visible at varying positions along the central lane 102, rendered as prominently colored blocks displaying the corresponding date labels. In the illustrated implementation, a current temporal position indicator 152 is displayed as a date block 132 labeled “Today” rendered in a distinct red color, identifying the user's present position along the navigable pathway. Additional date blocks 132 displaying “Saturday 25” in the foreground and “Monday 27” in the mid-ground are visible along the central lane 102, conveying the forward-extending temporal structure of the navigable pathway through perspective scaling.

A plurality of task markers 130 are positioned across the life lanes 104a-104f at varying distances along the navigable pathway, each reflecting its temporal deadline relative to the current temporal position indicator 152 through spatial position and visual prominence. In the illustrated implementation, a task marker 130 labeled “Salon Appointment” is positioned on a life lane 104a-104f in the foreground to the left of the central lane 102, and a task marker 130 labeled “Lunch with family” is positioned on an adjacent life lane 104a-104f at a comparable temporal position, each rendered as a three-dimensional block whose proximity to the current temporal position indicator 152 conveys its temporal urgency within the navigable pathway.

A convergence indicator 154 is rendered at a single temporal position spanning multiple life lanes 104a-104f in the mid-ground of the navigable pathway, visually distinguished from surrounding task markers 130 by a luminous star-shaped marker and a plurality of radiating visual signals emanating outward across the affected life lanes 104a-104f. In the illustrated implementation, the convergence indicator 154 is rendered as a gold star with green luminous signals radiating diagonally across two or more life lanes 104a-104f, illuminating a respective portion of each affected lane and visually identifying the corresponding task as a high-leverage activity producing meaningful benefit across multiple life domains simultaneously. A plurality of human figure indicators 156 are visible on the left side of the navigable pathway, representing people associated with tasks or life lanes 104a-104f within the graphical user interface 100.

The graphical user interface 100 further displays the people tab 138b on the left edge of the interface, and the resources tab 138c and bank tab 138d on the right edge of the interface, enabling the user to access people, resource, and financial information associated with tasks and life lanes 104a-104f without exiting the navigable pathway environment. A lane navigation control 140, a fly mode control 142, and a chat function 144 are visible along the bottom edge of the graphical user interface 100, together with a task creation icon 126 labeled “Add Task Events” positioned at the bottom right of the interface, enabling the user to add a new task marker 130 directly from the navigable pathway view. A navigate control 158 is displayed at the bottom center of the graphical user interface 100, enabling the user to control directional movement along the navigable pathway.

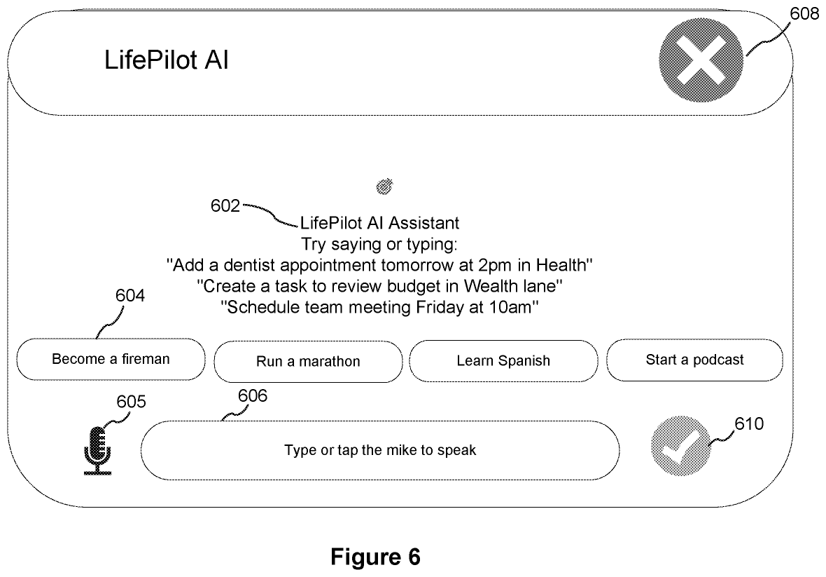

FIG. 6 illustrates an AI console dialog 600 of the graphical user interface 100, identified as the LifePilot AI console, through which the user engages the AI console 124 to create tasks, set goals, and receive planning assistance within the navigable pathway environment, in accordance with some implementations. The AI console dialog 600 is displayed as an overlay panel within the graphical user interface 100 and includes a header displaying the label “LifePilot AI.” A close button 608 is positioned at the upper right corner of the AI console dialog 600, enabling the user to dismiss the console and return to the navigable pathway.

An AI assistant prompt region 602 is displayed in the central area of the AI console dialog 600 and presents the user with contextual guidance for interacting with the AI console 124. The AI assistant prompt region 602 displays a target icon and the label “LifePilot AI Assistant,” followed by illustrative example commands including “Add a dentist appointment tomorrow at 2 pm in Health,” “Create a task to review budget in Wealth lane,” and “Schedule team meeting Friday at 10 am,” orienting the user to the range of natural language instructions the AI console 124 is configured to receive and process.

A plurality of goal suggestion indicators 604 are displayed as selectable pill-shaped buttons beneath the AI assistant prompt region 602, presenting the user with a set of pre-populated aspirational goal options. In the illustrated implementation, the goal suggestion indicators 604 display the options “Become a fireman,” “Run a marathon,” “Learn Spanish,” and “Start a podcast,” enabling the user to initiate a goal-setting workflow by selecting a suggested trajectory without requiring the user to formulate a goal from scratch. In some implementations, the goal suggestion indicators 604 are dynamically generated by the AI console 124 based on the user's existing task markers 130, life lane 104a-104f activity patterns, and historical convergence indicator data accumulated within the persistent data structure.

A microphone icon 605 is positioned at the lower left of the AI console dialog 600, enabling the user to activate voice command input. A text input field 606 is positioned adjacent to the microphone icon 605 and displays the placeholder text “Type or tap the mike to speak,” enabling the user to enter natural language commands via typed text or voice input interchangeably. A submit button 610 rendered as a green checkmark is positioned at the right of the text input field 606, enabling the user to confirm and submit the entered command to the AI console 124 for processing.

In some implementations, the AI console 124 addresses a core challenge in goal-setting by enabling the user to define future objectives through a visual selection process rather than through manual input. When the user selects a life lane 104a-104f within the navigable pathway, the graphical user interface 100 expands the selected life lane 104a-104f to reveal a set of plausible future trajectories generated by the AI console 124 based on the user's current activity patterns. The trajectories are visually differentiated within the navigable pathway and display gradual changes in the user's state over time, representing alternative future paths rather than fixed predictions. The user selects a preferred trajectory from the presented options, whereupon the selected trajectory collapses into the navigable pathway as the active course and the remaining trajectories fade from view. The endpoint of the selected trajectory is instantiated as a visual goal anchor rendered as a horizon marker 106a-106f on the horizon of the simulated three-dimensional perspective, and the AI console 124 automatically generates the intermediate steps and associated task markers 130 needed to reach the goal anchor, rendering those intermediate steps as task markers 130 positioned along the corresponding life lane 104a-104f at appropriate temporal positions. In some implementations, this process converts goal-setting from an abstract user-driven task into a visual selection process, reduces psychological resistance to long-term planning, and enables continuous course correction by allowing the user to revisit and modify selected trajectories over time through the AI console 124.

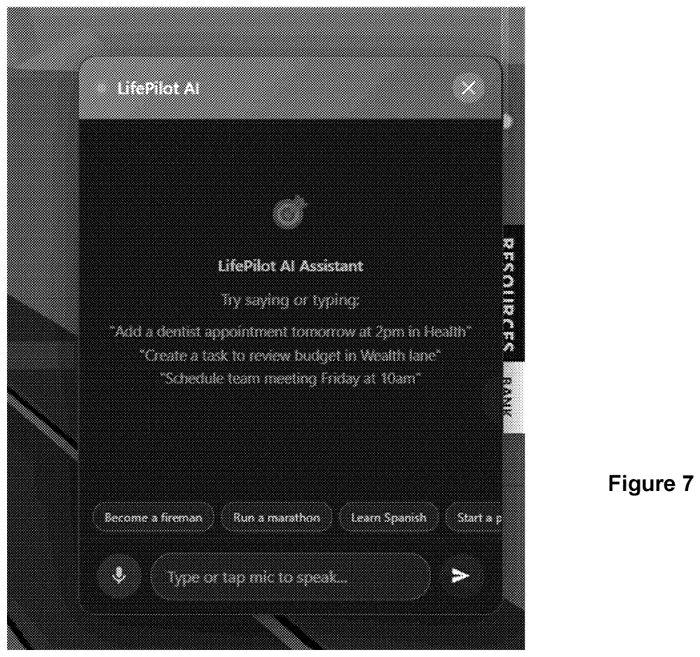

FIG. 7 illustrates a screenshot of the AI console dialog 600 of the graphical user interface 100 displayed in an operational state overlaid on the navigable pathway environment, in accordance with some implementations. FIG. 7 depicts the same AI console dialog 600 introduced in FIG. 6, rendered within the live navigable pathway environment with the simulated three-dimensional perspective visible in the background behind the AI console dialog 600.

The AI console dialog 600 is displayed as a floating overlay panel positioned over the navigable pathway, with the life lanes 104a-104f and the simulated three-dimensional environment partially visible in the background, confirming that the user may engage the AI console 124 without exiting the navigable pathway environment.

The header of the AI console dialog 600 displays a green active status indicator alongside the label “LifePilot AI,” confirming that the AI console 124 is active and ready to receive user input. The close button 608 is positioned at the upper right corner of the AI console dialog 600, enabling the user to dismiss the console and return to the navigable pathway.

The AI assistant prompt region 602 displays the target icon and the label “LifePilot AI Assistant,” followed by the instructional prompt “Try saying or typing:” and three illustrative example commands: “Add a dentist appointment tomorrow at 2 pm in Health,” “Create a task to review budget in Wealth lane,” and “Schedule team meeting Friday at 10 am.” The AI assistant prompt region 602 orients the user to the range of natural language instructions the AI console 124 is configured to receive and process, including task creation, scheduling, and life lane assignment commands entered via typed text or voice input.

The plurality of goal suggestion indicators 604 are displayed as selectable pill-shaped buttons at the bottom of the AI assistant prompt region 602, presenting the options “Become a fireman,” “Run a marathon,” “Learn Spanish,” and “Start a podcast,” with the fourth option partially visible at the right edge of the AI console dialog 600. The microphone icon 605 and text input field 606 are displayed at the bottom of the AI console dialog 600, with the text input field 606 displaying the placeholder text “Type or tap mic to speak . . . ”. The submit button 610 is rendered as a directional arrow icon positioned to the right of the text input field 606, enabling the user to submit a typed or voice-entered command to the AI console 124 for processing.

In some implementations, upon receiving a natural language command through the text input field 606 or via voice input through the microphone icon 605, the AI console 124 extracts the user's intent, identifies the relevant life lane 104a-104f, date, time, and task attributes specified in the command, and generates a corresponding task marker 130 positioned along the navigable pathway at the appropriate temporal position on the designated life lane 104a-104f, without requiring the user to manually complete the task creation dialog 200.

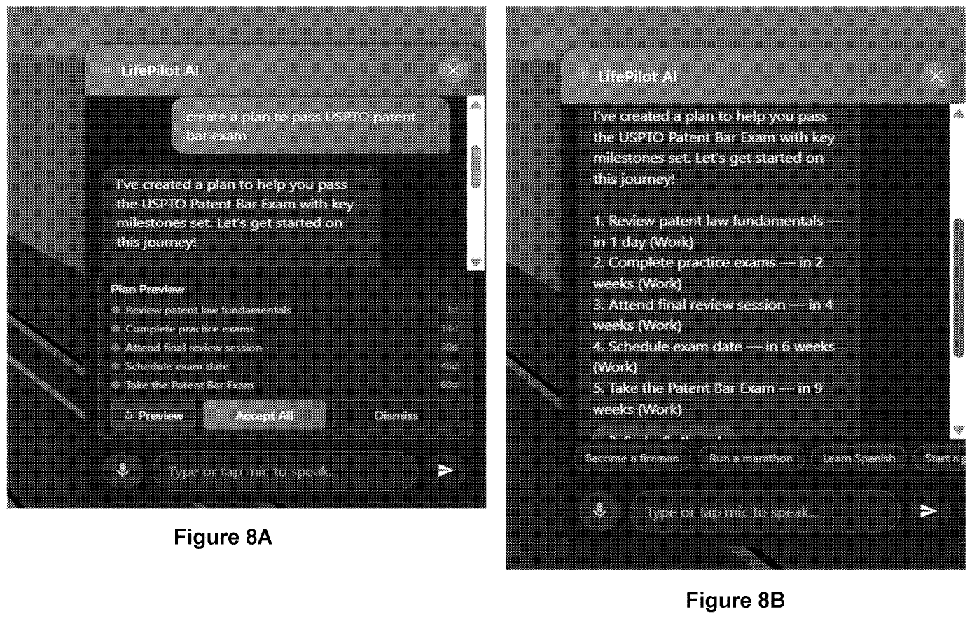

FIGS. 8A-8B illustrate a screenshot of the AI console dialog 600 of the graphical user interface 100 displaying an AI-generated plan in response to a natural language command entered by the user, in accordance with some implementations. FIG. 8 depicts the AI console dialog 600 in an active conversational state, with the navigable pathway environment visible in the background behind the AI console dialog 600.

The AI console dialog 600 displays a user message bubble rendered in a background at the upper portion of the conversational interface, containing the user-entered natural language command “create a plan to pass USPTO patent bar exam.” The user message bubble illustrates the AI console 124 receiving a goal-oriented planning request expressed in natural language, without requiring the user to manually specify individual task attributes or life lane assignments.

An AI response bubble is displayed below the user message bubble, rendered in a dark background, containing the AI console 124 response: “I've created a plan to help you pass the USPTO Patent Bar Exam with key milestones set. Let's get started on this journey!” The AI response bubble confirms that the AI console 124 has processed the user's natural language command, identified the underlying goal, and generated a structured plan comprising a sequence of task markers 130 to be placed along the navigable pathway.

A plan preview panel is displayed below the AI response bubble and presents the user with a structured list of AI-generated milestones, each representing a task marker 130 to be placed along the navigable pathway at a corresponding temporal position. The plan preview panel displays the following milestones with their respective temporal offsets from the current temporal position: “Review patent law fundamentals” at one day, “Complete practice exams” at fourteen days, “Attend final review session” at thirty days, “Schedule exam date” at forty-five days, and “Take the Patent Bar Exam” at sixty days. Each milestone is displayed with a circular status indicator and its corresponding temporal offset, enabling the user to review the complete sequence of generated task markers 130 prior to accepting placement on the navigable pathway.

A preview button is displayed at the bottom left of the plan preview panel enabling the user to visualize the placement of the AI-generated task markers 130 along the navigable pathway within the simulated three-dimensional perspective before committing to the plan. An accept all button is displayed at the center of the plan preview panel enabling the user to confirm acceptance of all AI-generated task markers 130 and spatially arrange them simultaneously along the corresponding life lane 104a-104f at their respective temporal positions on the navigable pathway. A dismiss button is displayed at the right of the plan preview panel enabling the user to discard the AI-generated plan without placing any task markers 130 on the navigable pathway.

The microphone icon 605 and text input field 606 remain visible at the bottom of the AI console dialog 600, with the text input field 606 displaying the placeholder text “Type or tap mic to speak . . . ” and the submit button 610 positioned to the right, enabling the user to continue the conversational planning session with the AI console 124 or refine the generated plan through additional natural language input.

In some implementations, upon user selection of the accept all button, the AI console 124 spatially arranges each milestone as a task marker 130 on the designated life lane 104a-104f at the temporal position corresponding to its specified offset from the current temporal position indicator and the graphical user interface 100 immediately re-flows the navigable pathway to display the complete sequence of newly generated task markers 130 within the simulated three-dimensional perspective. In some implementations, upon user selection of the preview button, the graphical user interface 100 navigates forward along the navigable pathway to display each AI-generated task marker 130 at its proposed temporal position, enabling the user to visually assess the plan within the simulated environment prior to final acceptance.

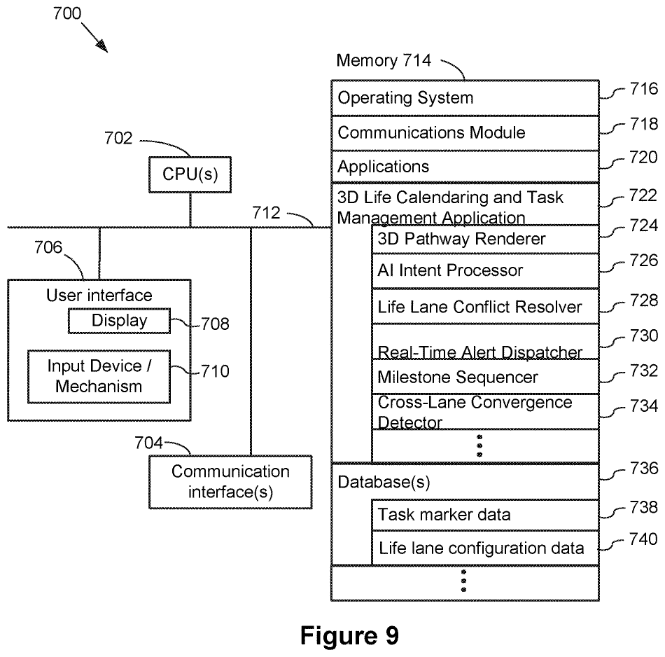

FIG. 9 is a block diagram of a computing device 700 in accordance with some implementations. Various examples of the computing device 700 include a desktop computer, a laptop computer, a tablet computer, and other computing devices that have a processor capable of running the 3D Life Calendaring and Task Management Application 722. In some implementations, the computing device 700 may be a server that hosts the 3D Life Calendaring and Task Management Application 722. In some implementations, the computing device 700 may be a virtual device configured to host or operate the 3D Life Calendaring and Task Management Application 722. The computing device 700 typically includes one or more processing units 702 for executing modules, programs, and instructions stored in the memory 714 and thereby performing processing operations, one or more network or other communications interfaces 704, memory 714, and one or more communication buses 712 for interconnecting these components. The communication buses 712 may include circuitry that interconnects and controls communications between system components.

The computing device 700 optionally includes a user interface 706 comprising a display device 708 and one or more input devices or mechanisms 710. In some implementations, the input device or mechanism 710 includes a keyboard. In some implementations, the input device or mechanism 710 includes a soft keyboard, which is displayed as needed on the display device 708, enabling a user to press keys that appear on the display device 708. In some implementations, the display device 708 and input device or mechanism 710 comprise a touch screen display, also called a touch sensitive display.

In some implementations, the memory 714 includes high-speed random-access memory, such as DRAM, SRAM, DDR RAM, or other random-access solid-state memory devices. In some implementations, the memory 714 includes non-volatile memory, such as one or more magnetic disk storage devices, optical disk storage devices, flash memory devices, or other non-volatile solid state storage devices. In some implementations, the memory 714 includes one or more storage devices remotely located from the processing units 702. The memory 714, or alternatively the non-volatile memory devices within the memory 714, comprises a non-transitory computer-readable storage medium. In some implementations, the memory 714, or the computer-readable storage medium of the memory 714, stores the following programs, modules, and data structures, or a subset thereof:
an operating system 716, which includes procedures for handling various basic system services and for performing hardware dependent tasks;
a communications module 718, which is used for connecting the computing device 700 to other computers and devices via the one or more communication interfaces 704, wired or wireless, and one or more communication networks such as the Internet, other wide area networks, local area networks, metropolitan area networks, and so on;
applications 720, which perform particular tasks or sets of tasks for the user, such as word processors, media players, web browsers, and communication platforms;
a 3D Life Calendaring and Task Management Application 722, configured to render the graphical user interface 100 depicting the simulated three-dimensional perspective of the navigable pathway, manage task markers 130 across the plurality of life lanes 104a-104f, coordinate AI agent operations within the navigable pathway environment, and deliver real-time visual and auditory feedback to the user. The 3D Life Calendaring and Task Management Application 722 includes one or more of:
   a 3D Pathway Renderer 724, which is configured to (i) render the simulated three-dimensional perspective of the navigable pathway extending in the forward direction, (ii) position task markers 130 along the life lanes 104a-104f at spatial positions reflecting their temporal deadlines relative to the user's current temporal position, (iii) render horizon markers 106a-106f as mountain-shaped goal anchors at the far end of the life lanes 104a-104f, and (iv) update the graphical user interface 100 in real time in response to user navigation input including forward traversal, backward traversal, lateral panning, and fly mode navigation along the navigable pathway;
   an AI Intent Processor 726, which is configured to (i) receive natural language inputs from the user through the AI console 124 via the text input field 606 or voice input through the microphone icon 605, (ii) parse the received inputs to extract intent, entities, and commands relevant to scheduling, rescheduling, or goal-setting across the plurality of life lanes 104a-104f, and (iii) route extracted commands to the appropriate component of the 3D Life Calendaring and Task Management Application 722 for processing and execution;
   a Life Lane Conflict Resolver 728, which is configured to (i) identify resource availability across the plurality of life lanes 104a-104f, (ii) detect scheduling conflicts between task markers 130 at overlapping or adjacent temporal positions, (iii) prioritize task execution based on urgency and importance attributes specified through the urgency selector 224 and importance selector 226, and (iv) re-flow downstream task markers 130 and flag temporal conflicts or resource clashes within the graphical user interface 100 in response to user modifications of task markers 130 along the navigable pathway;
   a Real-Time Alert Dispatcher 730, which is configured to (i) monitor task markers 130 across the plurality of life lanes 104a-104f for approaching temporal deadlines, scheduling changes, and AI agent recommendations, (ii) initiate real-time visual or auditory notifications to the user within the graphical user interface 100 upon detection of a scheduling change, temporal conflict, or optimization opportunity, and (iii) classify incoming notifications into priority levels and present them to the user without requiring the user to exit the navigable pathway environment;
   a Milestone Sequencer 732, which is configured to (i) analyze upcoming deadlines across the plurality of task markers 130 within the navigable pathway, (ii) generate intermediate milestone task markers 130 representing the prerequisite steps required to reach a goal anchor rendered as a horizon marker 106a-106f, (iii) present AI-generated plan previews to the user through the plan preview panel 616 within the AI console 124, and (iv) spatially arrange accepted milestone task markers 130 along the designated life lane 104a-104f at temporal positions corresponding to their specified offsets from the current temporal position indicator 152;
   a Cross-Lane Convergence Detector 734, which is configured to (i) identify task markers 130 designated as affecting two or more life lanes 104a-104f through the additional lane impacts dropdown menu 218a, (ii) evaluate whether the designated task meets configurable thresholds for impact, duration, or user-defined importance, (iii) generate a convergence indicator rendered as a luminous Shining Star visual marker extending across the affected life lanes 104a-104f at a single temporal position on the navigable pathway, (iv) maintain the convergence indicator as a persistent visual element at historical temporal positions, and (v) record convergence event attributes in a persistent data structure to inform AI agent prioritization of similar future activities; and
one or more databases 736, which are used by the applications 720 and the 3D Life Calendaring and Task Management Application 722. The one or more databases 736 store one or more of:
   task marker data 738, including attributes of each task marker 130 such as title, description, assigned life lane 104a-104f, date, time, duration, urgency level specified through the urgency selector 224, importance level specified through the importance selector 226, rendering style selected from doorway style 228, unavoidable style 230, high value task style 232, and screaming floater style 234, and temporal position along the navigable pathway;
   life lane configuration data 740, including user-defined life lane 104a-104f labels, spatial boundaries, visual attributes, associated horizon markers 106a-106f, and cross-domain dependency assignments recorded through the additional lane impacts dropdown menu 218a; and
additional data structures not shown in FIG. 9, including convergence event history, AI agent interaction history, and calendar synchronization data used by the components of the 3D Life Calendaring and Task Management Application 722 to personalize future recommendations and maintain synchronization with external calendar and productivity platforms.

Each of the above identified executable modules, applications, or sets of procedures may be stored in one or more of the previously mentioned memory devices and corresponds to a set of instructions for performing a function described above. The above identified modules or programs need not be implemented as separate software programs, procedures, or modules, and thus various subsets of these modules may be combined or otherwise re-arranged in various implementations. In some implementations, the memory 714 stores a subset of the modules and data structures identified above. Furthermore, the memory 714 may store additional modules or data structures not described above.

Although FIG. 9 shows a computing device 700, FIG. 9 is intended more as a functional description of the various features that may be present rather than as a structural schematic of the implementations described herein. In practice, and as recognized by those of ordinary skill in the art, items shown separately could be combined and some items could be separated.

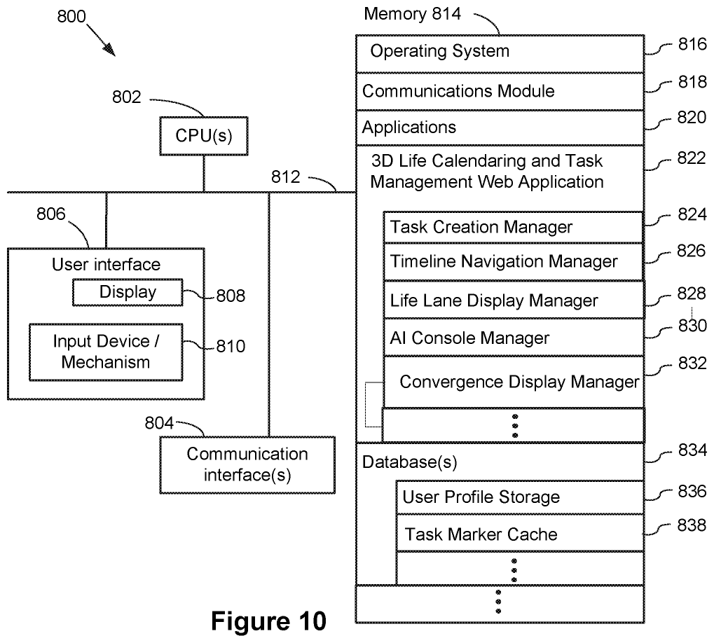

FIG. 10 is a block diagram of a user device 800 in accordance with some implementations. Various examples of the user device 800 include a desktop computer, a laptop computer, a tablet computer, a smartphone, and other computing devices that have a processor capable of running the 3D Life Calendaring and Task Management Web Application 822. In some implementations, the user device 800 may be a physical device such as a smartphone or a virtual device capable of running the 3D Life Calendaring and Task Management Web Application 822. The user device 800 typically includes one or more processing units 802 for executing modules, programs, and instructions stored in the memory 814 and thereby performing processing operations, one or more network or other communications interfaces 804, memory 814, and one or more communication buses 812 for interconnecting these components. The communication buses 812 may include circuitry that interconnects and controls communications between system components.

The user device 800 optionally includes a user interface 806 comprising a display device 808 and one or more input devices or mechanisms 810. In some implementations, the input device or mechanism 810 includes a keyboard. In some implementations, the input device or mechanism 810 includes a soft keyboard, which is displayed as needed on the display device 808, enabling a user to press keys that appear on the display device 808. In some implementations, the display device 808 and input device or mechanism 810 comprise a touch screen display, also called a touch sensitive display.

In some implementations, the memory 814 includes high-speed random-access memory, such as DRAM, SRAM, DDR RAM, or other random-access solid-state memory devices. In some implementations, the memory 814 includes non-volatile memory, such as one or more magnetic disk storage devices, optical disk storage devices, flash memory devices, or other non-volatile solid state storage devices. In some implementations, the memory 814 includes one or more storage devices remotely located from the processing units 802. The memory 814, or alternatively the non-volatile memory devices within the memory 814, comprises a non-transitory computer-readable storage medium. In some implementations, the memory 814, or the computer-readable storage medium of the memory 814, stores the following programs, modules, and data structures, or a subset thereof:
an operating system 816, which includes procedures for handling various basic system services and for performing hardware dependent tasks;
a communications module 818, which is used for connecting the user device 800 to other computers and devices via the one or more communication interfaces 804, wired or wireless, and one or more communication networks such as the Internet, other wide area networks, local area networks, metropolitan area networks, and so on;
applications 820, which perform particular tasks or sets of tasks for the user, such as word processors, media players, web browsers, and communication platforms;
a 3D Life Calendaring and Task Management Web Application 822, configured to facilitate the user's interaction with the navigable pathway environment, render the graphical user interface 100 on the display device 808 of the user device 800, and communicate with the computing device 700 to send user inputs and receive updated task marker 130 data, life lane 104a-104f configurations, convergence indicator states, and AI console 124 responses. The 3D Life Calendaring and Task Management Web Application 822 can send user-specified task attributes to the computing device 700 and receive back spatially arranged task markers 130 positioned along the navigable pathway, or can submit natural language commands through the AI console 124 and receive AI-generated plan sequences for display through the plan preview panel 616. The 3D Life Calendaring and Task Management Web Application 822 includes one or more of:
   a Task Creation Manager 824, which is configured to (i) manage the task creation dialog 200, including all input fields comprising the title field 204, description field 206, guardian message field 208, hyperlink box label field 210, send-to-hopper control 212, date field 214, time field 216, and life lane selector 218, (ii) process user input for urgency level through the urgency selector 224, importance level through the importance selector 226, and rendering style selection from doorway style 228, unavoidable style 230, high value task style 232, and screaming floater style 234, and (iii) communicate confirmed task marker 130 attributes to the computing device 700 upon user selection of the create task box button 236 for spatial arrangement along the designated life lane 104a-104f on the navigable pathway;
   a Timeline Navigation Manager 826, which is configured to (i) manage user navigation along the navigable pathway including forward movement via the forward arrow 108a, backward movement via the backward arrow 108b, lateral panning via the left arrow 110b and right arrow 110a, automatic traversal via the play button 118, paused navigation via the pause icon 116, and return to current temporal position via the jump-to-now icon 120, (ii) manage fly mode navigation via the fly mode control 142, and (iii) render an updated set of task markers 130 reflecting the current temporal position as the user navigates forward or backward along the navigable pathway;
   a Life Lane Display Manager 828, which is configured to (i) render the plurality of life lanes 104a-104f, central lane 102, date blocks 132, horizon markers 106a-106f, and vision indicators 114 within the simulated three-dimensional perspective of the navigable pathway, (ii) manage the life lane overview display through the life lane overview control 128, (iii) handle individual life lane navigation through the lane navigation control 140, and (iv) update the visual prominence and spatial position of task markers 130 within each life lane 104a-104f in accordance with their temporal deadlines relative to the current temporal position indicator 152;
   an AI Console Manager 830, which is configured to (i) manage the AI console dialog 600 including the AI assistant prompt region 602, goal suggestion indicators 604, microphone icon 605, text input field 606, and submit button 610, (ii) transmit natural language commands entered by the user to the AI Intent Processor 726 of the computing device 700 for intent extraction and processing, (iii) display AI-generated plan sequences through the plan preview panel 616 including the preview button 618, accept all button 620, and dismiss button 622, and (iv) render accepted AI-generated milestone task markers 130 along the designated life lane 104a-104f at their respective temporal positions on the navigable pathway upon user selection of the accept all button 620;
   a Convergence Display Manager 832, which is configured to (i) render convergence indicators as luminous Shining Star visual markers extending across two or more life lanes 104a-104f at a single temporal position on the navigable pathway, (ii) manage the visual display of luminous signals radiating outward across the affected life lanes 104a-104f, (iii) maintain convergence indicators as persistent visual elements at historical temporal positions as the user navigates the navigable pathway, and (iv) communicate cross-domain dependency assignments specified through the additional lane impacts dropdown menu 218a to the Cross-Lane Convergence Detector 734 of the computing device 700; and
one or more databases 834, which are used by the applications 820 and the 3D Life Calendaring and Task Management Web Application 822. The one or more databases 834 store one or more of:
   user profile storage 836, including user account information, life lane 104a-104f configuration preferences, theme selections, and personalization settings for the navigable pathway environment; and
   task marker cache 838, including locally cached task marker 130 attributes, temporal positions, life lane 104a-104f assignments, urgency and importance levels, and rendering styles, enabling the 3D Life Calendaring and Task Management Web Application 822 to render the navigable pathway without requiring a network request for each navigation event; and
additional data structures not shown in FIG. 10, including life lane configuration storage, AI interaction history cache, and convergence event cache used by the components of the 3D Life Calendaring and Task Management Web Application 822 to maintain a consistent navigable pathway environment across user sessions.

Each of the above identified executable modules, applications, or sets of procedures may be stored in one or more of the previously mentioned memory devices and corresponds to a set of instructions for performing a function described above. The above identified modules or programs need not be implemented as separate software programs, procedures, or modules, and thus various subsets of these modules may be combined or otherwise re-arranged in various implementations. In some implementations, the memory 814 stores a subset of the modules and data structures identified above. Furthermore, the memory 814 may store additional modules or data structures not described above.

Although FIG. 10 shows a user device 800, FIG. 10 is intended more as a functional description of the various features that may be present rather than as a structural schematic of the implementations described herein. In practice, and as recognized by those of ordinary skill in the art, items shown separately could be combined and some items could be separated.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method, performed at a computer having a display, one or more processors, and memory storing one or more programs configured for execution by the one or more processors, the one or more programs comprising instructions for:
displaying a graphical user interface depicting a simulated 3D perspective of a navigable pathway representing a timeline, the navigable pathway including:
a central lane, extending in a forward direction;
a plurality of blocks placed incrementally along the central lane, each block representing a respective date, which, upon user selection of a date, expands to display more granular time intervals for the selected date;
a plurality of life lanes, arranged perceptively parallel to central lane, and extending in the forward direction;
a plurality of horizon markers appearing perceptively near a far end of the plurality of the life lanes, each horizon marker representing a goal displayed as a mountain of a respective life lane;
a plurality of task markers, each task marker representing a respective task, wherein:
each task marker corresponding to a respective task having nearer temporal deadline is displayed with greater visual prominence and positioned perceptively nearer to a current temporal position on its respective life lane; and
each task marker corresponding to a respective task having later temporal deadline is displayed with reduced visual prominence and positioned perceptively further away on its respective life lane; and
receiving, via the graphical user interface, user input to add a task, wherein the user input specifies one or more of: (a) a first life lane of the plurality of life lanes; (b) a date; (c) a time; (d) a duration; (e) an urgency of the task; and (f) an importance of the task;
in accordance with the user input, spatially arranging the task as a task marker on the first life lane; and
in response to user input to navigate in the graphical user interface, navigating forward or backward in the simulated 3D perspective, displaying an updated set of task markers according to a current position in the timeline.

2. The method of claim 1, wherein the graphical user interface provides a plurality of alternative temporal perspectives with different time granularity.

3. The method of claim 1, wherein the plurality of alternative temporal perspectives include daily, weekly, monthly, and yearly perspectives.

4. The method of claim 1, further comprising:
receiving user input to specify a second task that is associated with two or more of the life lanes;
receiving user input to specify (a) a measure of impact of the second task on the two or more life lanes, (b) a duration of the second task, and/or (c) a user-specified importance of the second task;
in response to the user input to specify the second task, generating, on the display, a convergence indicator for the second task, wherein the convergence indicator:
is visually distinguished from other task markers;
extends across the two or more life lanes at a single temporal position; and
includes a luminous visual signal emanating outward across the two or more life lanes, illuminating a respective portion of each of the two or more life lanes.

5. The method of claim 4, wherein generating the convergence indicator further comprises:
maintaining the convergence indicator as a persistent visual element at a historical temporal position corresponding to the second task when the user navigates to historical temporal positions within the navigable pathway, wherein the convergence indicator remains visually distinguishable at the historical temporal positions;
recording attributes of the second task in a persistent data structure that accumulates a history of tasks satisfying one or more configurable thresholds across the plurality of life lanes; and
based on the persistent data structure, performing one or more of:
(a) identifying and displaying task markers having attributes corresponding to the recorded attributes during user navigation of the navigable pathway; and/or
(b) assigning a priority weight to future tasks having attributes corresponding to the recorded attributes and displaying the future tasks within the navigable pathway in accordance with the assigned priority weight.

6. The method of claim 1, wherein the method further comprises operating one or more AI-agents in conjunction with the graphical interface to perform one or more of:
(a) scheduling or rescheduling the plurality of tasks;
(b) executing an integration with one or more external services;
(c) initiating real-time communications with one or more users;
(d) generating optimization recommendations for the plurality of tasks; and/or
(e) updating the graphical interface to reflect changes or status information produced by the AI-agent, including displaying real-time visual or auditory feedback to the user.

7. The method of claim 6, wherein the AI-agents include one or more of:
(a) a natural language understanding module configured to parse user-generated inputs and extract intent, entities, or commands relevant to scheduling or rescheduling the plurality of tasks;
(b) a resource management module configured to identify resource availability, resolve conflicts, and prioritize task execution across the plurality of tasks;
(c) a notification dispatch module configured to initiate real-time visual or auditory notifications to affected users upon detection of a scheduling change, conflict, or AI-agent recommendation; and/or
(d) a project planning module configured to (i) analyze upcoming deadlines, (ii) generate recommendation beacons for incomplete prerequisites, and (iii) present choices via agent avatars.

8. The method of claim 6, wherein an AI-agent is configured to synchronize with existing calendar and other productivity platforms used by the user.

9. The method of clam 8, wherein the other productivity platforms used by the user include one or more of: Google Calendar, Apple Calendar, Gmail services, Outlook services, and other reminder applications.

10. The method of claim 1, further comprising:
rendering an AI console within the graphical interface, the AI console providing a user interaction layer between the user and the one or more AI-agents, wherein the AI console:
(a) displays real-time status information of each AI-agent;
(b) receives user input to override, approve, or reject an action proposed or executed by an AI-agent;
(c) presents logs, alerts, or optimization recommendations generated by the one or more AI-agents; and/or (d) suggests a plurality of goals that can be assigned to horizon markers.

11. The method of claim 10, wherein suggesting a plurality of goals further comprises:
generating, for each suggested life goal assigned to a horizon marker of a respective life lane, a multi-step progression plan including:
(a) a respective plurality of incremental goals distributed at successive temporal positions along the respective life lane within the navigable pathway, each incremental goal representing a respective intermediate milestone toward a respective final goal assigned to a respective horizon marker; and
(b) displaying each incremental goal as a task marker on the respective life lane at a respective temporal position within the navigable pathway so that the respective plurality of incremental goals collectively define a respective visual progression path toward the respective horizon marker.

12. The method of claim 1, further comprising receiving user input to specify size, color intensity, or proximity of a task marker corresponding to an urgent task.

13. The method of claim 1, further comprising receiving user input to specify traversal of the navigable pathway by flying or driving, and, in response, displaying the navigable pathway according to the traversal specification.

14. The method of clam 1, further comprising receiving taps, swipes, voice commands from the user to traverse the navigable pathway.

15. The method of claim 1, further comprising receiving user input to designate a second task marker as a signpost, an icon, a volumetric object, or other visual element.

16. The method of claim 1, wherein the plurality of life lanes define a life theme, including one or more of: a health lane, a family lane, a wealth lane, a love lane, a work lane, a faith lane, a mission lane, a creativity lane, and/or a social life lane.

17. The method of claim 1, wherein each task marker is positioned either on a simulated ground plane or at an elevation or orientation within the simulated 3D navigable perspective so that each task marker can hover, ascend, descend, or be arranged volumetrically as needed to convey additional semantic or contextual information.

18. The method of claim 1, wherein a respective perceived distance of each task marker from the user's navigable view is directly proportional to a time remaining until the a respective due date of the respective task, according to a linear scale or a logarithmic scale.

19. A computing device, comprising:
one or more processors;
memory;
a display; and
one or more programs stored in the memory and configured for execution by the one or more processors, the one or more programs comprising instructions for:
displaying a graphical user interface depicting a simulated 3D perspective of a navigable pathway representing a timeline, the navigable pathway including:
a central lane, extending in a forward direction;
a plurality of blocks placed incrementally along the central lane, each block representing a respective date, which, upon user selection of a date, expands to display more granular time intervals for the selected date;
a plurality of life lanes, arranged perceptively parallel to central lane, and extending in the forward direction;
a plurality of horizon markers appearing perceptively near a far end of the plurality of the life lanes, each horizon marker representing a goal displayed as a mountain of a respective life lane;
a plurality of task markers, each task marker representing a respective task, wherein:
each task marker corresponding to a respective task having nearer temporal deadline is displayed with greater visual prominence and positioned perceptively nearer to a current temporal position on its respective life lane; and
each task marker corresponding to a respective task having later temporal deadline is displayed with reduced visual prominence and positioned perceptively further away on its respective life lane; and
receiving, via the graphical user interface, user input to add a task, wherein the user input specifies one or more of: (a) a first life lane of the plurality of life lanes; (b) a date; (c) a time; (d) a duration; (e) an urgency of the task; and (f) an importance of the task;
in accordance with the user input, spatially arranging the task as a task marker on the first life lane; and
in response to user input to navigate in the graphical user interface, navigating forward or backward in the simulated 3D perspective, displaying an updated set of task markers according to a current position in the timeline.

20. A non-transitory computer-readable storage medium storing one or more programs configured for execution by a computing device having one or more processors, memory, and a display, the one or more programs comprising instructions for:
displaying a graphical user interface depicting a simulated 3D perspective of a navigable pathway representing a timeline, the navigable pathway including:
a central lane, extending in a forward direction;
a plurality of blocks placed incrementally along the central lane, each block representing a respective date, which, upon user selection of a date, expands to display more granular time intervals for the selected date;
a plurality of life lanes, arranged perceptively parallel to central lane, and extending in the forward direction;
a plurality of horizon markers appearing perceptively near a far end of the plurality of the life lanes, each horizon marker representing a goal displayed as a mountain of a respective life lane;
a plurality of task markers, each task marker representing a respective task, wherein:
each task marker corresponding to a respective task having nearer temporal deadline is displayed with greater visual prominence and positioned perceptively nearer to a current temporal position on its respective life lane; and
each task marker corresponding to a respective task having later temporal deadline is displayed with reduced visual prominence and positioned perceptively further away on its respective life lane; and
receiving, via the graphical user interface, user input to add a task, wherein the user input specifies one or more of: (a) a first life lane of the plurality of life lanes; (b) a date; (c) a time; (d) a duration; (e) an urgency of the task; and (f) an importance of the task;
in accordance with the user input, spatially arranging the task as a task marker on the first life lane; and
in response to user input to navigate in the graphical user interface, navigating forward or backward in the simulated 3D perspective, displaying an updated set of task markers according to a current position in the timeline.
